(19) United States
(12) Patent Application Publication
(10) Pub. No.: US 2002/0032589 A1
(43) Pub. Date: Mar. 14, 2002

(54) System and method for providing an advanced personal information manager

(75) Inventor: Niraj A. Shah, Issaquah, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: InfoSpace, Inc.

(21) Appl. No.: 09/952,622

(22) Filed: Sep. 13, 2001

Related U.S. Application Data
(60) Provisional application No. 60/232,458, filed on Sep. 13, 2000.

(51) Int. Cl. G06F 17/60

(52) U.S. Cl. 705/6

(57) ABSTRACT

A system and method for integrating calendaring and reservation processes are provided. A user obtains an appointment request. A personal information management application determines whether one or more reservations, including travel reservations, are needed as part of the appointment. Accordingly, the user can accept the appointment request and make the appropriate reservation as a single transaction.

### CROSS-REFERENCE TO RELATED APPLICATION

This application claims the benefit of U.S. Provisional Patent Application No. 60/232,458, filed Sep. 13, 2000, the disclosure of which is hereby incorporated by reference.

### FIELD OF THE INVENTION

In general, the present application relates to computer software and computer communication networks and, in particular, to a system and method for utilizing an advanced personal information management system to integrate calendaring and reservation processes.

### BACKGROUND OF THE INVENTION

Generally described, the implementation of computing devices, such as personal computers, mobile communication devices, and personal digital assistants, has facilitated organizational aspects of everyday life. In one embodiment, for example, there are several computing devices with software applications designed to maintain a calendar of appointments for an individual, or group of individuals.

In a common embodiment, a user can receive a request for an appointment, such as a meeting, lunch or dinner appointment, etc., and can enter the appointment into the software application. In turn, the software application can remind the user of upcoming appointments and can alert the user of any potential conflicts between appointments. By managing appointments via a calendaring software application, a user can often access calendar information from a variety of computing devices connected to a common computer network. Furthermore, in the case of a mobile computing device, a user can maintain a calendar of appointments while traveling or attending remote meetings, etc.

Although the utilization of software applications having a calendaring process facilitates some aspects of managing a user's appointments, the determination of whether to accept or reject an appointment request can involve a number of additional processes. More specifically, the acceptance of an appointment can involve the creation of any number of reservations to allow an individual to complete the appointment. In one embodiment, an appointment request may require a user to travel to another city. Accordingly, in addition to accepting the appointment request, the user may have to make airline, car rental, and hotel reservations. If the reservations cannot be made or if the expense of the reservations exceeds a budgeted limit, than the appointment may have to be canceled or otherwise modified. In another embodiment, even if the appointment request does not require the user to physically travel, the acceptance of the appointment may still require the reservation of meeting rooms, restaurant reservations, or even accommodations for visiting guests. Similar to the previous embodiment, if the appropriate reservations cannot be timely made or the reservations exceed a budgeted amount, the appointment may have to be canceled, or otherwise modified.

In a conventional embodiment, some travel reservations may be facilitated through a travel service provider. For example, a user may be able to make airline reservations and car rental reservations through an Internet-based travel service or travel provider. The user may also be required to make other reservations, such as meeting room, restaurant reservations, etc., by calling a corresponding provider. Often, however, the user may not have access to all the information required to make the appropriate reservations, such as telephone numbers, credit card numbers, frequent flyer numbers, etc., especially if the user is utilizing a mobile communication device from a remote location.

Because additional reservations associated with an accepted appointment are typically attempted at some time after the appointment is initially accepted, a user often is inconvenienced in having to reschedule appointments if the reservations cannot be made. Moreover, in some situations, a user may forget to make the necessary reservations in a timely fashion that may cause the appointment to be missed.

Thus, there is a need for a system and method for integrating calendaring and reservation processes to facilitate the management of appointment requests.

### SUMMARY OF THE INVENTION

A system and method for integrating calendaring and reservation processes are provided. A user obtains an appointment request. A personal information management application determines whether one or more reservations, including travel reservations, are needed as part of the appointment. Accordingly, the user can accept the appointment request and make the appropriate reservation as a single transaction.

In accordance with an aspect of the present invention, a method for integrating a calendaring and a reservation request is provided. A personal information management (“PIM”) application obtains a request for an appointment. The PIM application determines whether the appointment corresponds to one or more possible reservations. The PIM application displays a set of reservations items corresponding to the appointment request and obtains the user selection of at least one reservation item. The PIM application transmits a reservation request corresponding to the user's selection of the reservation items.

In accordance with another aspect of the present invention, a method for integrating a calendaring and reservation request in a mobile computing device having a display and at least one input device is provided. The mobile device displays a request for an appointment. The mobile device determines whether the appointment request corresponds to one or more possible reservations. The mobile device displays a set of reservation items on the mobile device display corresponding to the appointment request and obtains from the input device a user selection of at least one reservation item. The mobile device transmits the user's selection.

In accordance with yet another aspect of the present invention, a personal information system for integrating calendaring and reservation processes is provided. The personal information system includes one or more mobile devices having a display. The personal information system further includes a personal information manager server operable to determine whether a user appointment request corresponds to one or more possible reservations. The personal information manager server is further operable to transmit a set of reservation items corresponding to an appointment request. Additionally, the mobile device is operable to display the set of reservation items, to obtain the user's selection of the set of reservation items, and to transmit the selection to the personal information manager server.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a representative portion of the Internet;

FIG. 2 is a block diagram of a personal information management system utilized to integrate calendaring and reservation processes in accordance with the present invention;

FIG. 3 is a block diagram depicting an illustrative architecture for a mobile device utilized to execute a personal information manager in accordance with the present invention;

FIG. 4 is a block diagram depicting an illustrative architecture for a personal information server utilized to communication with one or more mobile devices executing personal information managers in accordance with the present invention;

FIG. 5 is a flow diagram illustrative of a personal information management routine implemented by a personal information manager application of a mobile device in accordance with the present invention;

FIG. 6 is a block diagram illustrative of a menu screen display produced by a mobile device having a personal information manager in accordance with the present invention;

FIG. 7 is a block diagram illustrative of a menu screen display produced by a mobile device having a personal information manager in accordance with the present invention;

FIG. 8 is a block diagram illustrative of meeting request screen display produced by a mobile device having a personal information manager in accordance with the present invention;

FIG. 9 is a block diagram illustrative of a reservation processing screen display produced by a mobile device having a personal information manager in accordance with the present invention;

FIG. 10 is a flow diagram illustrative of a reservation processing subroutine implemented by a personal information server in accordance with the present invention;

FIG. 11 is a block diagram illustrative of an airline travel reservation selection screen display produced by a mobile device having a personal information manager in accordance with the present invention;

FIG. 12 is a block diagram illustrative of an airline travel reservation screen display produced by a mobile device having a personal information manager in accordance with the present invention;

FIG. 13 is a block diagram illustrative of an airline travel information screen display produced by a mobile device having a personal information manager in accordance with the present invention;

FIG. 14 is a block diagram of a reservation selection menu screen display produced by a mobile device having a personal information manager in accordance with the present invention;

FIG. 15 is a block diagram of a hotel reservation screen display produced by a mobile device having a personal information manager in accordance with the present invention;

FIG. 16 is a block diagram of a hotel reservation selection screen display produced by a mobile device having a personal information manager in accordance with the present invention;

FIG. 17 is a block diagram of a car rental reservation screen display produced by a mobile device having a personal information manager in accordance with the present invention;

FIG. 18 is a block diagram of a car rental reservation selection screen display produced by a mobile device having a personal information manager in accordance with the present invention;

FIG. 19 is a block diagram of a calendaring selection screen display produced by a mobile device having a personal information manager in accordance with the present invention; and

FIG. 20 is a block diagram of a calendaring and reservation confirmation screen display produced by a mobile device having a personal information manager in accordance with the present invention.

### DETAILED DESCRIPTION OF AN ILLUSTRATIVE EMBODIMENT

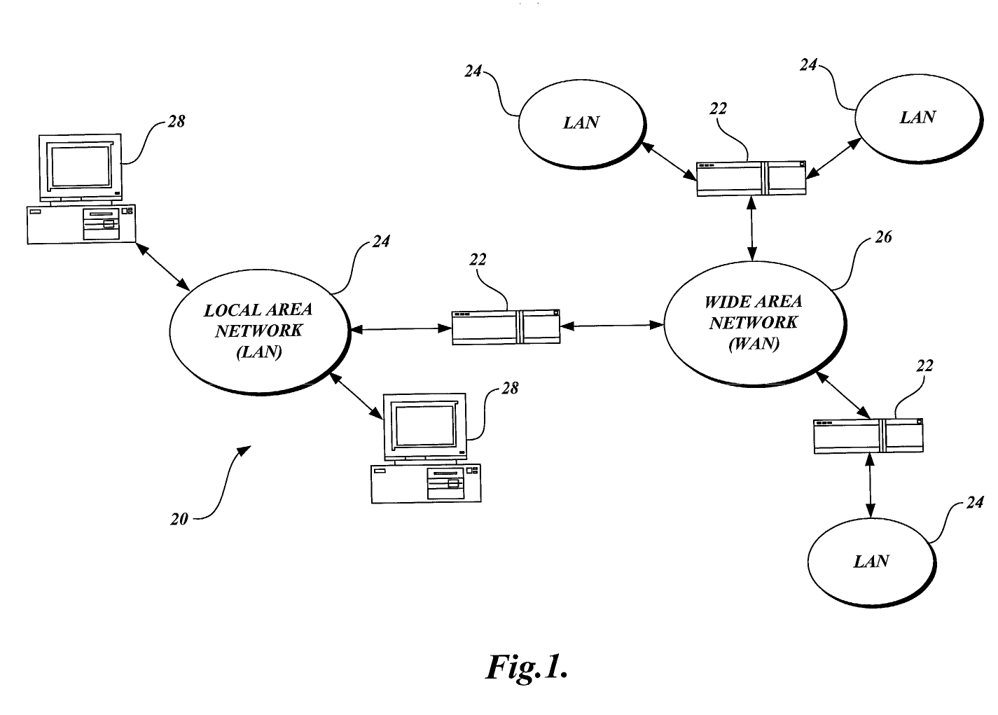

As described above, aspects of the present invention are embodied in a World Wide Web (“WWW” or “Web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, where a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, coaxial cable, or optical fiber, while communication links between networks may utilize 56 Kbps analog telephone lines, 1 Mbps digital T-1 lines, 45 Mbps T-3 lines, or other communications links known to those skilled in the art.

Furthermore, computers 28 and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”) or other markup languages, which are electronically stored at “WWW sites” or “Web sites” throughout the Internet. Other interactive hypertext environments may include proprietary environments, such as those provided in America Online or other online service providers, as well as the “wireless Web” provided by various wireless networking providers, especially those in the cellular phone industry. It will be appreciated that the present invention could apply in any such interactive hypertext environments; however, for purposes of discussion, the Web is used as an exemplary interactive hypertext environment with regard to the present invention.

A Web site is a server/computer connected to the Internet that has massive storage capabilities for storing hypertext documents and that runs administrative software for handling requests for those stored hypertext documents. Imbedded within a hypertext document are a number of hyperlinks, i.e., highlighted portions of text that link the document to another hypertext document possibly stored at a Web site elsewhere on the Internet. Each hyperlink is assigned a Uniform Resource Locator (“URL”) that provides the exact location of the linked document on a server connected to the Internet and describes the document. Thus, whenever a hypertext document is retrieved from any Web server, the document is considered retrieved from the World Wide Web. Known to those skilled in the art, a Web server may also include facilities for storing and transmitting application programs, such as application programs written in the JAVA® programming language from Sun Microsystems, for execution on a remote computer. Likewise, a Web server may also include facilities for executing scripts and other application programs on the Web server itself.

A consumer or other remote access user may retrieve hypertext documents from the World Wide Web via a Web browser program. A Web browser, such as Netscape's NAVIGATOR® or Microsoft's Internet Explorer, is a software application program for providing a graphical user interface to the WWW. Upon request from the consumer via the Web browser, the Web browser locates and retrieves the desired hypertext document from the appropriate Web server using the URL for the document and the HTTP protocol. HTTP is a higher-level protocol than TCP/IP and is designed specifically for the requirements of the WWW. HTTP runs on top of TCP/IP to transfer hypertext documents between server and client computers. The WWW browser may also retrieve programs from the Web server, such as JAVA applets, for execution on the client computer.

The present application is directed toward a system and method for integrating calendaring and reservation processes. Specifically, the present invention is directed toward a system and method for utilizing a personal information manager on computing device, such as a mobile device, to integrate calendaring and reservation processes. However, one skilled in the relevant art will appreciate that although the present invention will be described in accordance with a particular mobile device and illustrative screen displays, the disclosed embodiments are only illustrative in nature and should not be construed as limiting.

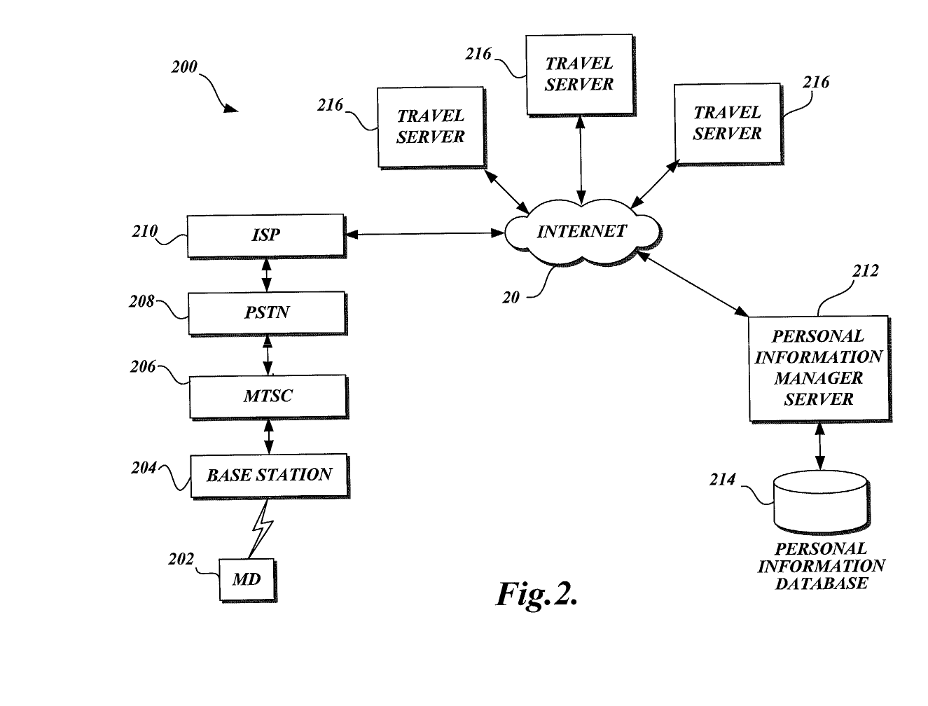

FIG. 2 is a block diagram of a personal information management system 200 utilized to integrate calendaring and reservation processes in accordance with the present invention. The personal information management system 200 includes one or more mobile devices 202 utilized a consumer to communicate with the personal information management system. To establish communications, a mobile device 202 is in communication with one or more base stations 204, such as a cellular base station, which include a transceiver and a controller for transmitting and receiving wireless communication data from the mobile device 202. In turn, the base stations 204 are in communication with a mobile telephone switching center (“MTSC”) 206. The MTSC 206 is known to those skilled in the relevant art as a digital telephone exchange that controls switching between the base stations 204 and a public switched telephone network (“PSTN”) 208 for all wireline-to-mobile, mobile-to-wireline, and mobile-to-mobile calls. As will be readily understood by one skilled in the relevant art, the processing of wireless communication may entail additional or alternative components and/or steps. Accordingly, the system disclosed in FIG. 2 is intended solely for illustrative purposes and will not be described in any greater detail.

With continued reference to FIG. 2, the PSTN 208 establishes a communication link with an Internet service provider (“ISP”) 210 for establishing network connectivity to the mobile device 202. The connection of the PSTN 208 to the ISP 210 is accomplished via telephone lines, or alternatively, through dedicated or semi-dedicated network lines. Although only a single mobile device is illustrated in FIG. 2, one skilled in the relevant art will appreciate that the personal information management system 200 may include any number of mobile devices 202, base stations 204, MTSCs 206, PSTNs 208, and ISPs 210.

The personal information management system 200 also includes a personal information manager server 212 operable to communicate with the one or more mobile devices 202 of the system 200. The personal information manager server 212 may include a personal information database 214 that can include personal information profiles for one or more users. The utilization of the personal information manager server 212 and the personal information database 214 will be explained in greater detail below.

With continued reference to FIG. 2, the personal information management system 200 also includes one or more travel servers 216 operable to reserve various travel-related aspects for users of the system 200. In an illustrative embodiment of the present invention, the travel server 216 can include independent third-party services interfaced with the personal information management system 200. Alternatively, one or more of the travel servers 216 can include servers provided for exclusive use for the personal information management system 200.

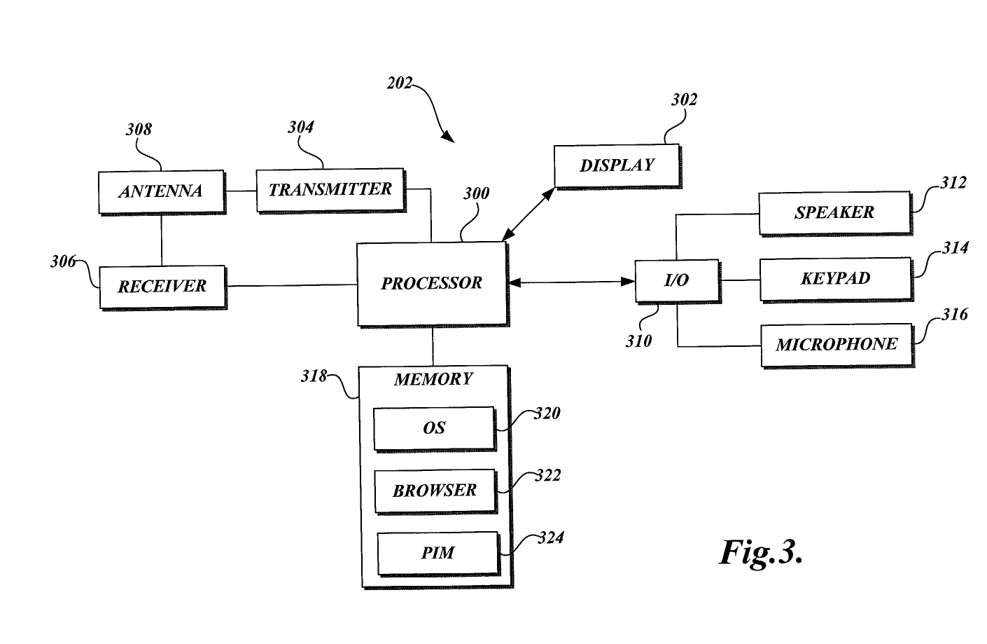

FIG. 3 depicts several of the key components of the mobile device 202. Those of ordinary skill in the art will appreciate that the mobile device 202 includes many more components then those illustrated in FIG. 3. However, it is not necessary that all of these generally conventional components be shown in order to disclose an illustrative embodiment for practicing the invention. Additionally, those of ordinary skill in the art will further appreciate that alternative components and/or methods for establishing mobile communications is considered within the scope of the present invention

As shown in FIG. 3, the mobile device 202 includes a processor 300, a display 302 and a memory 318. The display 302 may include any variety of display devices including, but not limited to a liquid crystal display, a color display, a light emitting diode display, and a combination thereof. Also connected to the processor 300 is an input/output interface 310, which connects to a speaker 312, a keypad 314, and a microphone 316. As would be readily understood by one skilled in the relevant art, alternative input/output configurations are considered to be within the scope of the present invention. The mobile device 202 also includes a transmitter 304 and receiver 306, which are connected to an antenna 308 for sending and receiving wireless communications respectively. The mobile device 202 may also include a modulator and demodulator for formatting data transmissions according to an air interface standard. It should be understood that the mobile device 202 may be capable of operating with one or more air interface standards, modulation types and data accessing types without departing from the scope of the invention.

The memory 318 generally comprises a random access memory (“RAM”), a read-only memory (“ROM”) and may also include a permanent mass storage device, such as a hard disk drive, tape driver, optical drive, floppy disk driver, CD-ROM, DVD-ROM or removable storage drive. The memory 318 stores an operating system 320 for controlling operation of the mobile device 202. The memory 318 also includes a WWW browser 322 for accessing the WWW. The browser 322 may be specially configured to receive and transmit data from a mobile device utilizing protocols such as the wireless markup language (“WML”), M-Services, and the like. The memory 318 further includes a personal information manager (“PIM”) application 324 utilized to obtain and process information from the personal information manager server 212 (FIG. 2). It will be appreciated that these components may be stored on various computer-readable mediums and loaded into memory 318 using a drive medium associated with the computer-readable medium.

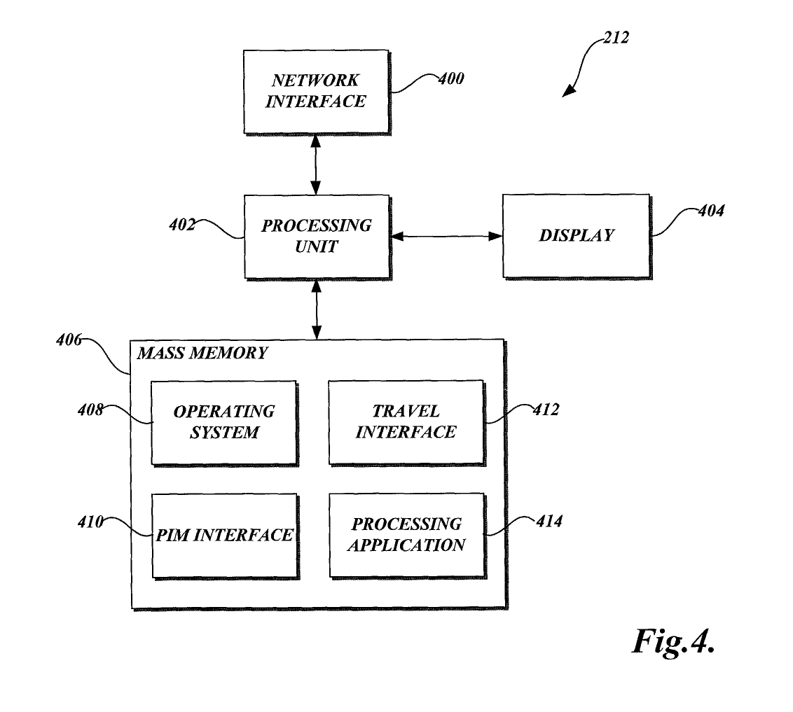

FIG. 4 is a block diagram depicting an illustrative architecture of a personal information manager server 212 (FIG. 2) in accordance with the present invention. Those of ordinary skill in the art will appreciate that the personal formation manager server 212 includes many more components than those shown in FIG. 4. However, it is not necessary that all of these generally conventional components be shown in order to disclose an illustrative embodiment for practicing the present invention. As shown in FIG. 4, the personal information manager server 212 is connected to the Internet 20 via a network interface 400. Those of ordinary skill in the art will appreciate that the network interface 400 includes the necessary circuitry for connecting the personal information manager server 212 to the Internet 20, and is constructed for use with the TCP/IP protocol, or other protocols, such as Internet Inter-ORB Protocol (“IIOP”).

The personal information manager server 212 also includes a processing unit 402, a display 404, and a mass memory 406, all connected via a communication bus or other communication device. The mass memory 406 generally comprises a RAM, ROM, and a permanent mass storage device, such as a hard disk drive, tape drive, optical drive, floppy disk drive, or combination thereof. The mass memory 406 stores an operating system 408 for controlling the operation of the personal information manager server 212. It will be appreciated that this component may comprise a general-purpose server operating system as is known to those skilled in the art, such as UNIX, LINUX™, or Microsoft WINDOWS NT®.

The mass memory 406 also stores program code and data for interfacing with various user mobile devices 202 and various travel servers 216 of the personal information management system 200. More specifically, the mass memory 406 stores a PIM interface application 410 accordance with the present invention for communication with one or more mobile devices 202 having a PIM 324 (FIG. 3). The PIM interface application 410 comprises computer-executable instructions which, when executed by the personal information manager server 212, transmits and receives PIM data, as will be explained below in greater detail. The mass memory 406 also stores a travel server interface application program 412 for communicating with one or more travel servers to generate user reservations. The operation of the travel server interface application 412 will be described in greater detail below.

The mass memory 406 further stores a processing application 414 for associating PIM data, user profile data, and travel reservation data in accordance with the personal information management system 200. The operation of the processing application 414 will be described in greater detail below. It will be appreciated that these components may be stored on a computer-readable medium and loaded into the memory 406 of the personal information manager server 212 using a drive mechanism associated with the computer-readable medium, such as a floppy, CD-ROM, DVD-ROM drive, or network interface 400.

In accordance with the present invention, a user, via a mobile device 202, obtains a request for a scheduled appointment. The request may originate from another user enrolled in the personal information management system 200 or from an external user not enrolled in the system. If the user accepts the appointment request, the PIM application 324, either independently or through the PIM interface application 410 of the personal information manager server 212, determines whether one of various reservations need to be made in response to the accepted appointment. More specifically, in an illustrative embodiment of the present invention, the PIM application 324 determines whether airline reservations, hotel reservations, car rental reservations, and/or restaurant reservations need to be made. If so, the travel server interface 412 of the personal information manager server 212 can communicate with one or more travel servers 216, or other travel service providers, to make the appropriate reservations. Accordingly, the PIM application 324 facilitates the generation of reservation requests with the acceptance of an appointment.

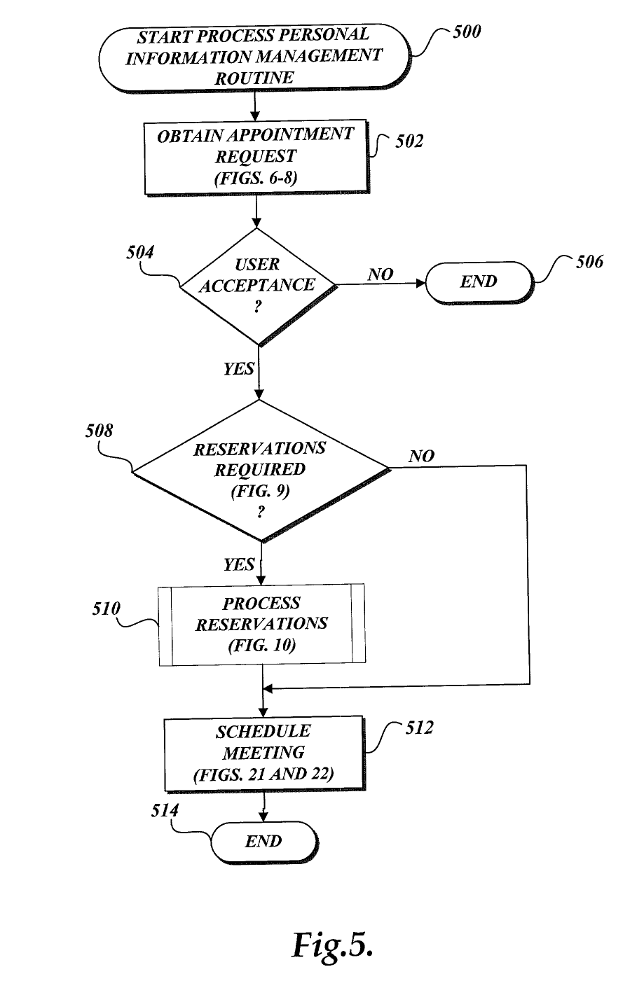

FIG. 5 is a flow diagram illustrative of a personal information management routine implemented by the PIM application 324 of the mobile device 202, in accordance with the present invention. In an illustrative embodiment of the present invention, the PIM application 324 may be utilized to generate various screen displays and process the appointment and reservation data. Alternatively, the personal information manager server 212 may execute some or all of the data processing capability and transmit the results to the PIM application 324 of the mobile device 202. Accordingly, the routines of the present invention may be executed by more than one computing device within the personal information management system 200.

With reference to FIG. 5, at block 502, the PIM application 324 obtains an appointment request. In an illustrative embodiment of the present invention, the appointment request may be obtained by the personal information manager server 212 and stored within the personal information database 214. The PIM interface 410 may alert the PIM application 324 of the mobile device 202 that an appointment request has been received. Alternatively, the appointment request may be stored for retrieval whenever the PIM application 324 requests new appointment information. In an alternative embodiment, the appointment request may be transmitted directly to the mobile device 202 for review by a user.

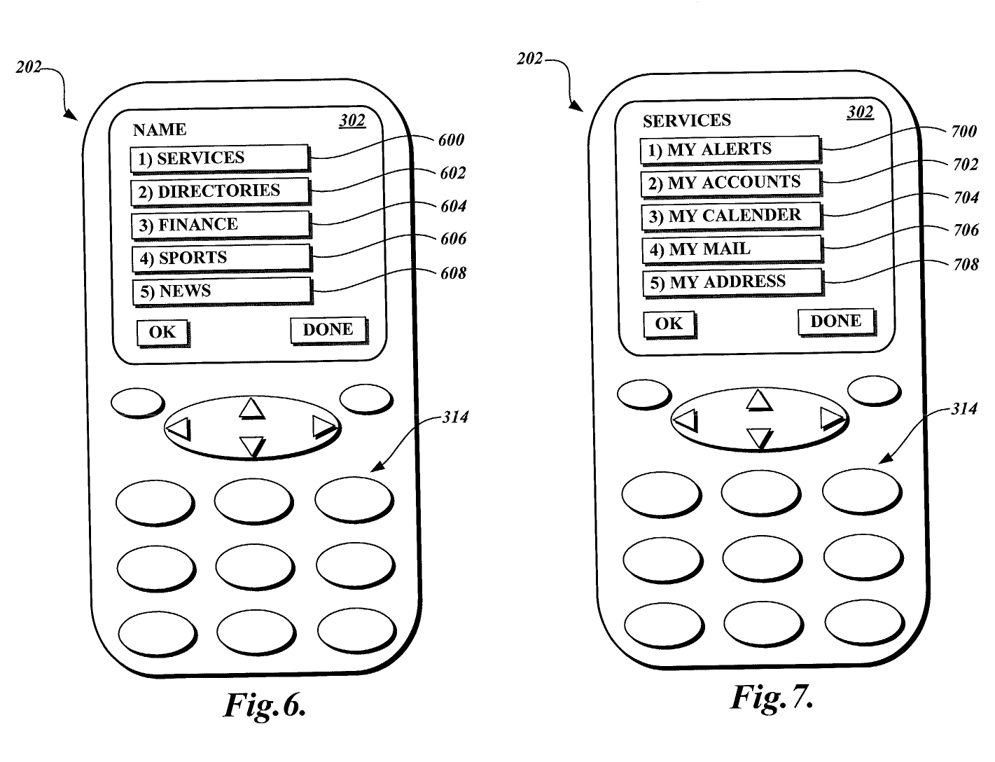

FIGS. 6-8 are block diagrams of various screen displays generated by a mobile device 202 illustrating the retrieval of a newly received appointment request by the PIM application 324. In an illustrative embodiment of the present invention, the mobile device 202 may provide a user with a variety of services, one of which includes the PIM application 324 of the present invention. Accordingly, the user may have to navigate one or more menu screen displays to access the PIM application 324. With reference to FIG. 6, the screen display 302 may include a primary menu screen display that includes a “Services” field 600, a “Directories” field 602, a “Finance” field 604, a “Sports” field 606, and a “News” field 608. Depending on the input capabilities of the mobile device 202, to access the PIM application 324, a user would select the “Services” field 600, such as by entering a corresponding number with the keypad 314, by manipulating a pointing device, by issuing a voice command, or a combination thereof.

Referring now to FIG. 7, the mobile device 202 may also have additional menu screen displays to access appointment requests. As illustrated in FIG. 7, the screen display 302 can include a “My Alerts” field 700, a “My Accounts” field 702, a “My Calendar” field 704, a “My Mail” field 706, and a “My Address” field 708. As previously described, depending on the input capabilities of the mobile device 202, a user would select the “My Calendar” field 704 by entering a corresponding number with the keypad 314, by manipulating a pointing device, by issuing a voice command, or a combination thereof.

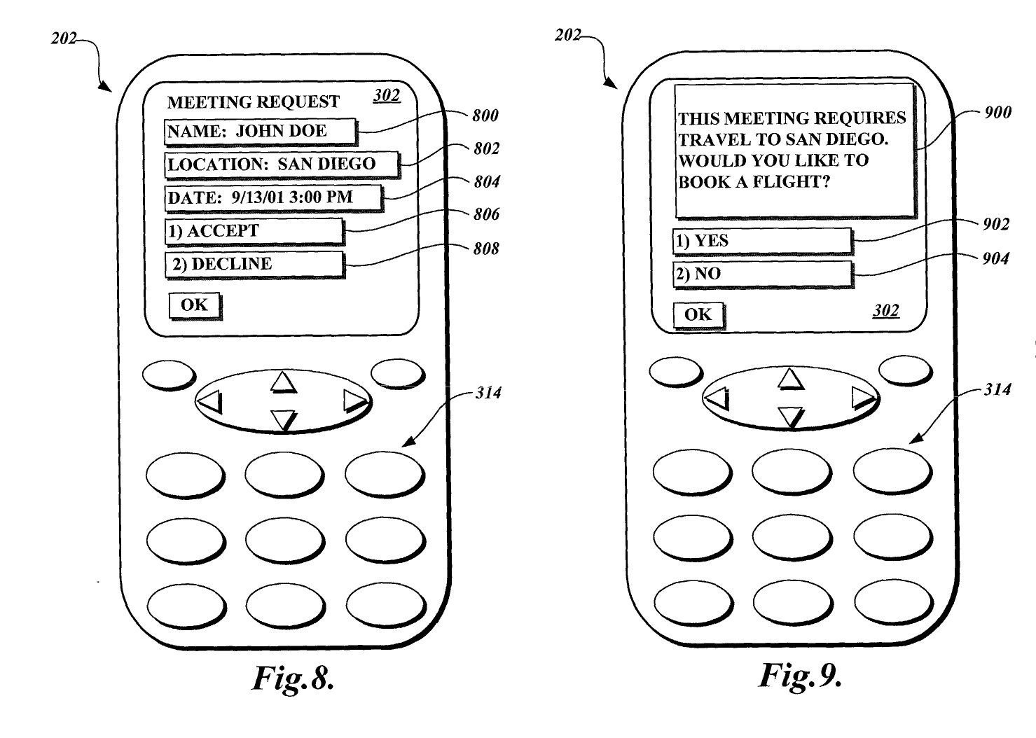

One skilled in the relevant art will appreciate that the mobile device 202 may present a user with anyone of a variety of interfaces and/or menu screen displays to access an appointment request. Referring now to FIG. 8, after accessing the appropriate menu option, the mobile device 202 can generate a screen display 302 for informing the user of an appointment request. As illustrated in FIG. 8, the screen display 302 can include a Name field 800 for informing the user the persons involved in the appointment. The screen display 302 can also include a Location field 802 for informing the user of the location of the appointment, if applicable. The screen display 302 can further include a Time/Date field 804 for informing the user of the time and/or date of the appointment. The screen display 302 can also include an “Accept” field 806 and a “Decline” field 804 for obtaining the user's decision of the meeting request.

Returning to FIG. 5, at decision block 504, a test is conducted to determine whether the user has accepted the appointment request. In an illustrative embodiment of the present invention, if the PIM application 324 is processing the data, the user's selection is registered upon input. Alternatively, if the data processing application 414 of the personal information manager server 212 is processing the data, the user's selection is obtained by the mobile device 202 and transmitted to the personal information manager server. If the user declines the appointment request, the routine 500 terminates at block 506.

If at decision block 504, the user accepts the appointment request, at decision block 508, a test is conducted to determine whether one or more reservations are required. In an illustrative embodiment of the present invention, the PIM application 324 can determine a user location, such as by querying the user, utilizing global positioning system data, and any other positioning calculation methods and compare the user location to determine whether a travel reservation will be necessary. Accordingly, the PIM application 324 may automatically initiate a travel reservation or it may poll for a user indication.

FIG. 9 is a block diagram of a screen display 302 generated by a mobile device querying a user whether they wish to make a travel reservation. As illustrated in FIG. 9, the screen display 302 includes an alert field 900 for informing the user of potentially necessary travel. The screen display 320 also includes an accept field 902 and a decline field 904 for obtaining the user input. Depending on the input capabilities of the mobile device 202, a user would respond to the alert field 900 by selecting the accept field 902 or the decline field 904 by manipulating the keypad 314 or a pointing device, by issuing a voice command, or a combination thereof.

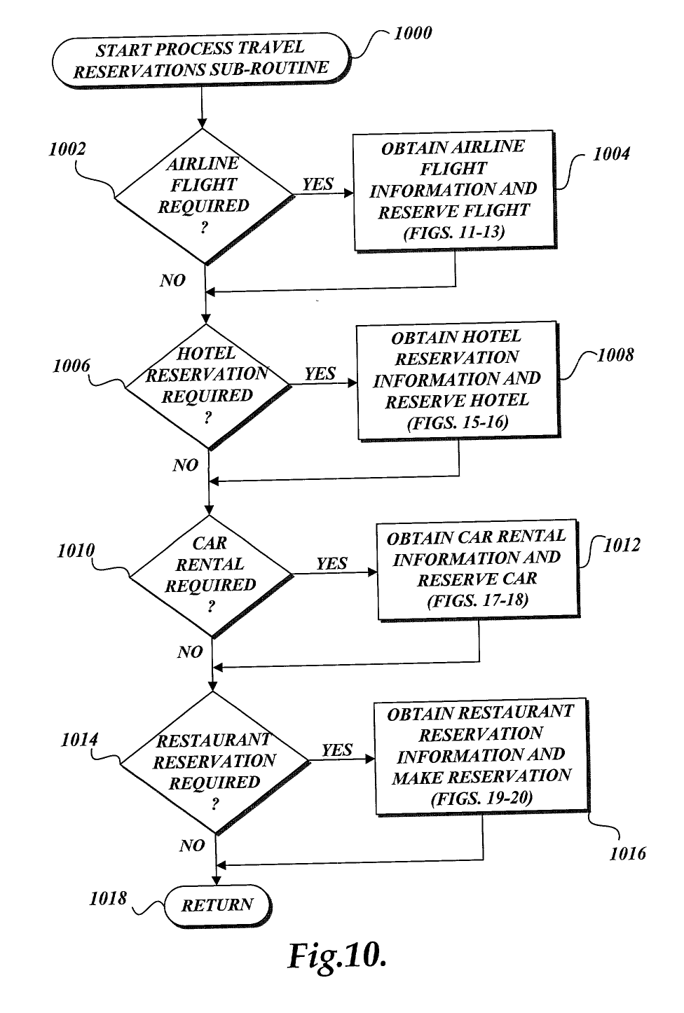

Returning to FIG. 5, if the user declines to make a reservation, the routine 500 proceeds to block 512, which will be explained in greater detail below. Alternatively, if the user indicates that he or she wishes to make a reservation, at block 510, the PIM application 324 processes the reservation request. FIG. 10 is a flow diagram illustrative of a reservation request processing subroutine 1000 implemented by the PIM application 324 of the mobile device 202. As explained above, in an illustrative embodiment of the present invention, the PIM application 324 may be utilized to generate various screen displays and process the appointment and reservation data. Alternatively, the personal information manager server 212 may execute some or all of the data processing capability and transmit the results to the PIM application 324 of the mobile device 202. Accordingly, the routines of the present invention may be executed by more than one computing device within the personal information management system 200.

With reference to FIG. 10, at decision block 1002, a test is conducted to determine whether an airline flight is required. In an illustrative embodiment of the present invention, the PIM application 324 make automatically determine whether an airline flight is necessary by comparing whether the location of the user and the location of the appointment is greater than an established travel distance. Alternatively, as illustrated in FIG. 9, the PIM application 324 may also make the determination, or confirm the determination, by obtaining a user indication of whether an airline reservation would like to be made.

If no airline flight is needed, such as by receiving a user declination, the subroutine 1000 proceeds to decision block 1006, which will be explained in detail below. Alternatively, if an airline reservation is desired, at block 1004, the PIM application 324 obtains airline flight information and attempts to reserve a flight. In an illustrative embodiment of the present invention, the PIM application 324 interfaces with the PIM interface application 410 of the personal information manager server 212 to obtain the airline flight reservation data. In turn, the travel interface application 412 of the personal information manager server 212 may interface with one or more travel servers 216 to obtain the relevant flight information data. Additionally, the processing application 414 of the personal information manager server 212 may also obtain a user's personal information, such identification number, reservation preference data, credit card numbers, frequent flyer information, and the like, from the personal information database 214 to facilitate the processing of the reservation.

FIGS. 11-13 are block diagrams of various mobile device screen displays 302 illustrated the processing of an airline reservation corresponding to an appointment request in accordance with the present invention. With reference to FIG. 11, the screen display 302 can include various fields for allowing the user to select the appropriate departure and arrival locations. More specifically, in an illustrative embodiment, the screen display 302 includes a departure field 1100 and an arrival field 1102. Additionally, the screen display 302 can include an action field 1104, allowing the user to proceed with the display of flights corresponding to the selected departure and arrival locations. In an illustrative embodiment of the present invention, the PIM application 324 may designate some default field values from the departure field 1100 and the arrival field 1102. Additionally, the PIM application 324 may further utilize some user arrival or departure location preference selections obtained from the personal information database 214.

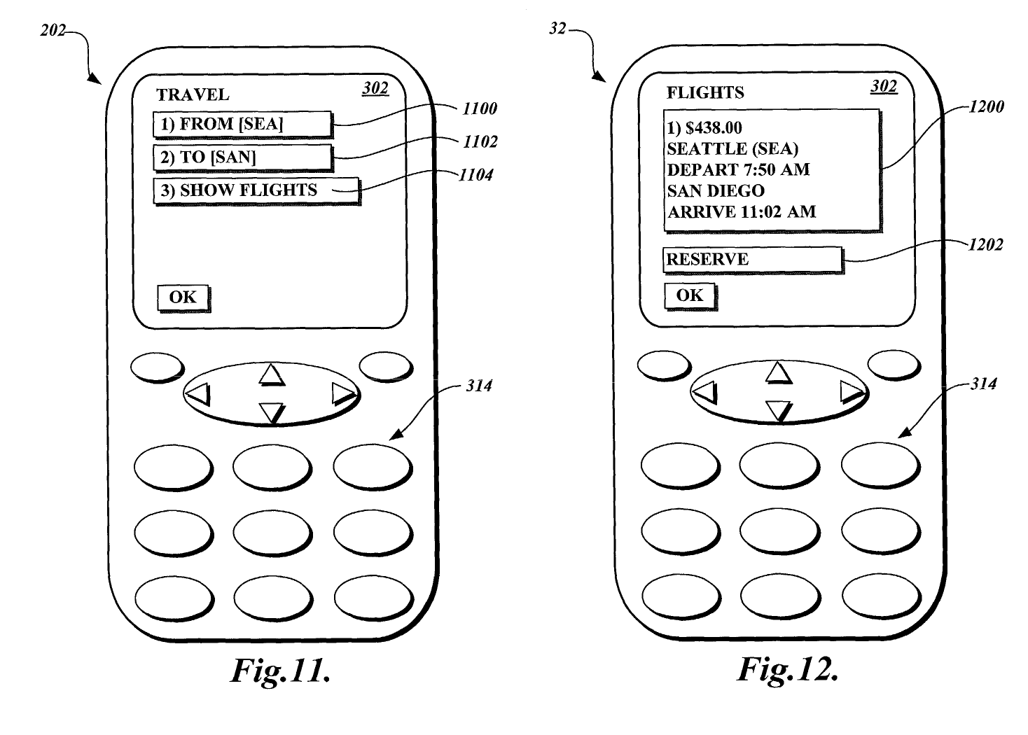

Once the user has elected to obtain flight information, the PIM application 324 can generate one or more screen displays for displaying detailed data regarding available airline flights. Referring now to FIG. 12, an illustrative screen display 302 can include a detailed data field 1200 for displaying airline flight information to the user. In an illustrative embodiment of the present invention, the detailed data field 1200 can provide information such as airline provider, flight times, flight locations, price, and the like, which will allow the user to select a desired flight. The screen display 302 can also include an action field 1202 that will allow the user to indicate a desire to reserve the particular airline flight.

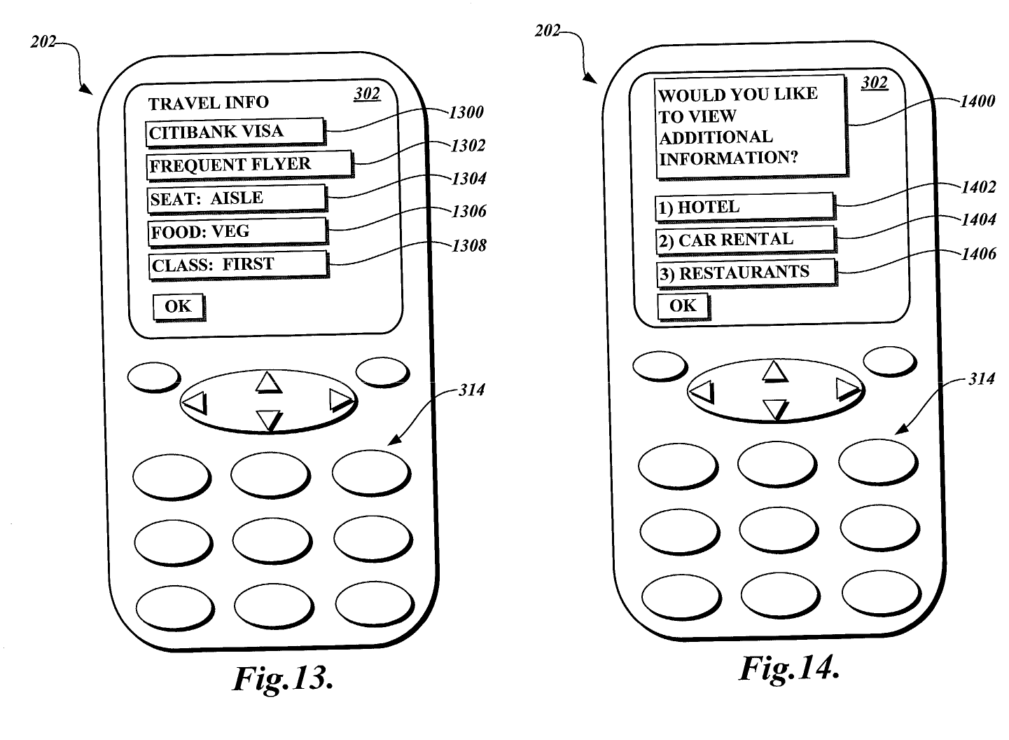

Once the user has selected a particular airline flight, the PIM application 324 can generate one or more screen display for obtaining user specific data for making the reservation. Referring now to FIG. 13, an illustrative screen display can include a designated credit card field 1300, a frequent flyer account field 1302, a preferred seat type field 1304, a food type field 1306, and a preferred seating class field 1308. In an illustrative embodiment of the present invention, the PIM application 324 may include default values for the fields by obtaining user reservation preferences from the personal information database 214. Additionally, the user can manipulate the field data by manipulating the keypad 314 or a pointing device, by issuing a voice command, or a combination thereof.

Returning to FIG. 10, if an airline flight reservation is not desired at decision or once an airline flight is reserved, at decision block 1006, a test is conducted to determine whether a hotel reservation is required. FIG. 14 is a block diagram of a screen display 302 illustrating a reservation selection menu generated by a mobile device 202 in accordance with the present invention. As illustrated in FIG. 14, the screen display 302 can include a text field 1400 for querying the user for additional information, or recapping any previous selections. The screen display 302 can further include one or more reservation identification fields 1402, 1404, and 1406 that will allow the user to designate a desire to make any additional reservations. In an illustrative embodiment of the present invention, the PIM application 324 may modify the reservation selection menu fields if a reservation is either not possible or would not be needed. For example, if the user is not traveling, the PIM application 324 may eliminate the display of a car rental reservation field 1406.

If no hotel reservation is needed, such as by receiving a user declination, the subroutine 1000 proceeds to decision block 1010, which will be explained in detail below. Alternatively, if a hotel reservation is desired, at block 1008, the PIM application 324 obtains hotel reservation data and attempts to make a reservation. Similar to the airline reservation process of block 1004, in an illustrative embodiment of the present invention, the PIM application 324 interfaces with the PIM interface application 410 of the personal information manager server 212 to obtain the hotel reservation data. In turn, the travel interface application 412 of the personal information manager server 212 may interface with one or more travel servers 216 to obtain the relevant hotel reservation data. Additionally, the processing application 414 of the personal information manager server 212 may also obtain a user's personal information, such identification number, reservation preference data, credit card numbers, and the like, from the personal information database 214 to facilitate the processing of the reservation.

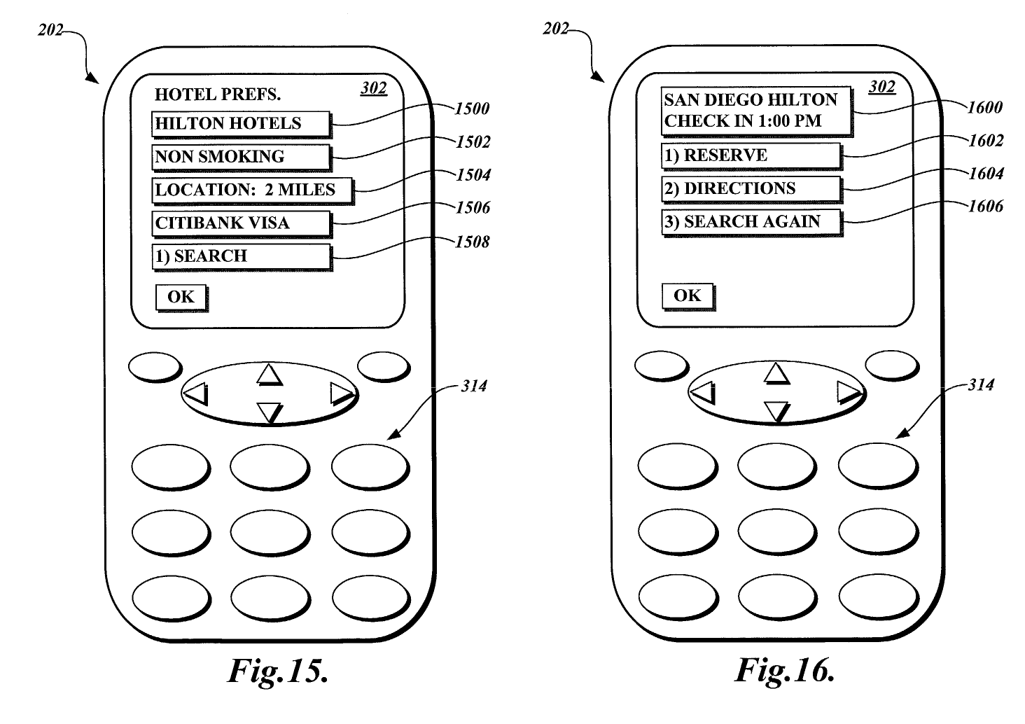

FIGS. 15-16 are block diagrams of various mobile device screen displays 302 illustrated the processing of a hotel reservation corresponding to an appointment request in accordance with the present invention. With reference to FIG. 15, the screen display 302 can include various fields for allowing the user to select a hotel room reservation. More specifically, in an illustrative embodiment, the screen display 302 includes a hotel chain preference field 1500, a smoking preference field 1502, a location range field 1504, and a payment type field 1506. The PIM application 324 may include default values for the fields by obtaining user reservation preferences from the personal information database 214. Additionally, the user can manipulate the field data by manipulating the keypad 314 or a pointing device, by issuing a voice command, or a combination thereof. The screen display 302 can also include an action field 1508 for allowing the user to instruct the PIM application 324 to search for applicable hotel reservations.

In an illustrative embodiment of the present invention, the PIM application 324 may transmit the user preferences/selections to the PIM interface application 410. Once any corresponding hotel reservations have been found, the PIM application 324 may display the hotel reservation information to the user. FIG. 16 is a block diagram illustrative of a screen display utilized by the PIM application 324 to provide a user with more detailed information regarding a potential hotel reservation. The screen display can include a detail field 1600 for displaying details of the hotel reservation. The screen display 302 can also include a number of actions fields 1602, 1604, and 1606 for allowing the user reserve the hotel, obtain directions for the hotel, and/or search for additional hotel reservations. Similar to some of the other screen displays, the user can manipulate the field data by manipulating the keypad 314 or a pointing device, by issuing a voice command, or a combination thereof.

Returning to FIG. 10, if a hotel reservation is not desired or once a hotel reservation has been made, at decision block 1010, a test is conducted to determine whether a car rental reservation is required. Referring again to FIG. 14, a user may be presented with a reservation selection menu to make a selection of any applicable reservations by manipulating the keypad 314 or a pointing device, by issuing a voice command, or a combination thereof.

If no car rental reservation is needed, such as by receiving a user declination, the subroutine 1000 proceeds to decision block 1014, which will be explained in detail below. Alternatively, if a car rental reservation is desired, at block 1012, the PIM application 324 obtains car rental reservation data and attempts to make a reservation. Similar to the airline reservation process of block 1004 and the hotel reservation process of block 1008, in an illustrative embodiment of the present invention, the PIM application 324 interfaces with the PIM interface application 410 of the personal information manager server 212 to obtain the car rental reservation data. In turn, the travel interface application 412 of the personal information manager server 212 may interface with one or more travel servers 216 to obtain the relevant car rental reservation data. Additionally, the processing application 414 of the personal information manager server 212 may also obtain a user's personal information, such identification number, reservation preference data, credit card numbers, and the like, from the personal information database 214 to facilitate the processing of the reservation.

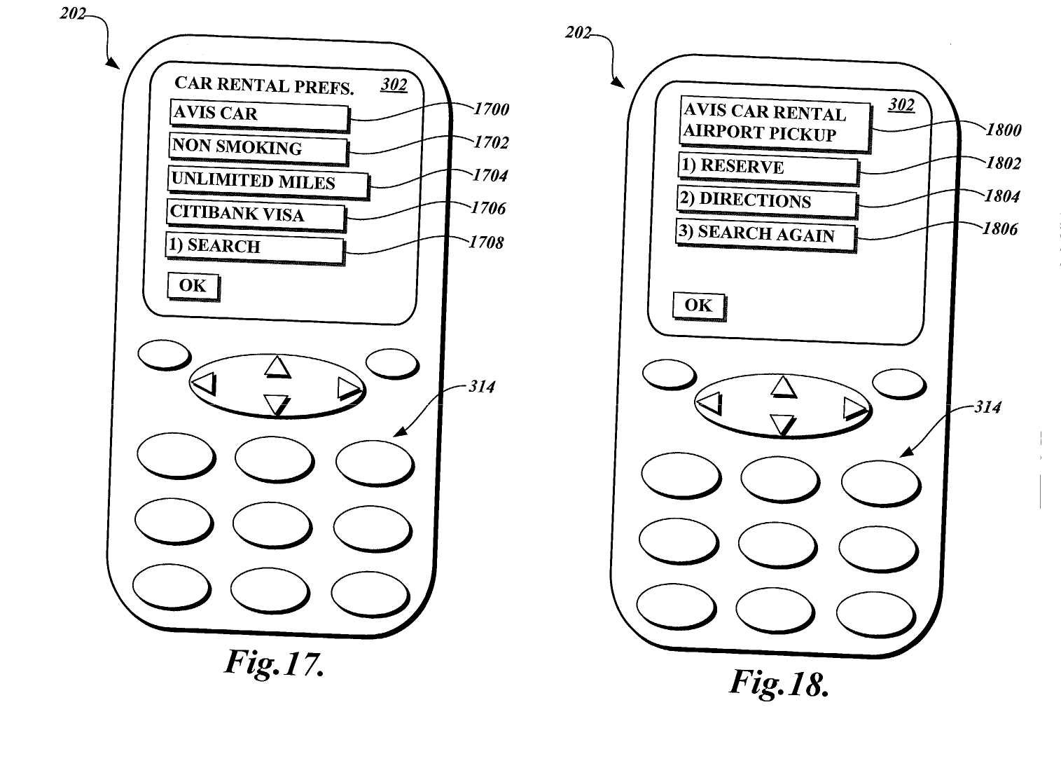

FIGS. 17-18 are block diagrams of various mobile device screen displays 302 illustrated the processing of a car rental reservation corresponding to an appointment request in accordance with the present invention. With reference to FIG. 17, the screen display 302 can include various fields for allowing the user to select a car rental reservation. More specifically, in an illustrative embodiment, the screen display 302 includes a car rental company preference field 1700, a smoking preference field 1702, a mileage field 1704, and a payment type field 1706. The PIM application 324 may include default values for the fields by obtaining user reservation preferences from the personal information database 214. Additionally, the PIM application 324 may utilize additional information from the appointment request, such as location, to facilitate the identification of applicable car rental agencies. The user can also manipulate the field data by manipulating the keypad 314 or a pointing device, by issuing a voice command, or a combination thereof. The screen display 302 can also include an action field 1708 for allowing the user to instruct the PIM application 324 to search for applicable car rental reservations.

In an illustrative embodiment of the present invention, the PIM application 324 may transmit the user preferences/selections to the PIM interface application 410. Once any corresponding hotel reservations have been found, the PIM application 324 may display the car rental reservation information to the user. FIG. 18 is a block diagram illustrative of a screen display utilized by the PIM application 324 to provide a user with more detailed information regarding a potential car rental reservation. The screen display can include a detail field 1800 for displaying details of the hotel reservation. The screen display 302 can also include a number of actions fields 1802, 1804, and 1806 for allowing the user reserve the car, obtain directions to the car rental agency, and/or search for additional car rental reservations. Similar to some of the other screen displays, the user can manipulate the field data by manipulating the keypad 314 or a pointing device, by issuing a voice command, or a combination thereof.

Returning to FIG. 10, if a car rental reservation is not desired or once a car rental reservation has been made, at decision block 1014, a test is conducted to determine whether a restaurant reservation is required. Referring again to FIG. 14, a user may be presented with a reservation selection menu to make a selection of any applicable reservations by manipulating the keypad 314 or a pointing device, by issuing a voice command, or a combination thereof.

If no restaurant reservations are needed, such as by receiving a user declination, the subroutine 1000 terminates at block 1018. Alternatively, if a restaurant reservation is desired, at block 1016, the PIM application 324 obtains restaurant reservation data and attempts to make a reservation. Similar to the airline reservation process of block 1004, the hotel reservation process of block 1008 and the car rental reservation process of block 1012, in an illustrative embodiment of the present invention, the PIM application 324 interfaces with the PIM interface application 410 of the personal information manager server 212 to obtain the restaurant reservation data. In turn, the travel interface application 412 of the personal information manager server 212 may interface with one or more restaurant servers 216 to obtain the relevant restaurant reservation data. Additionally, the processing application 414 of the personal information manager server 212 may also obtain a user's personal information, such identification number, reservation preference data, credit card numbers, and the like, from the personal information database 214 to facilitate the processing of the reservation.

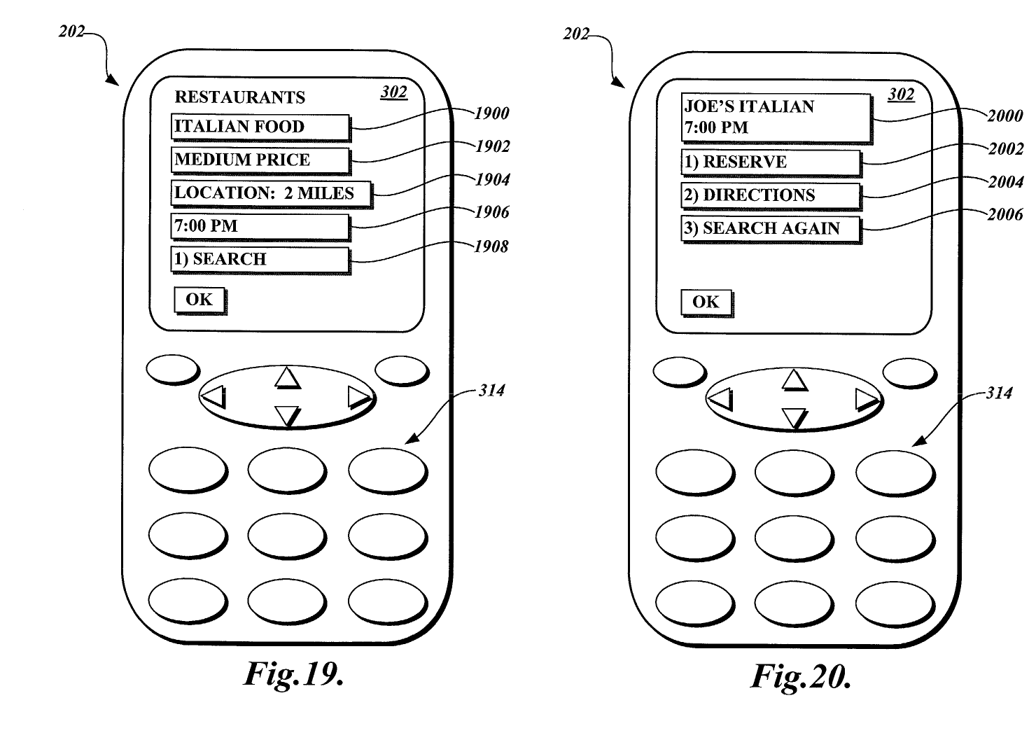

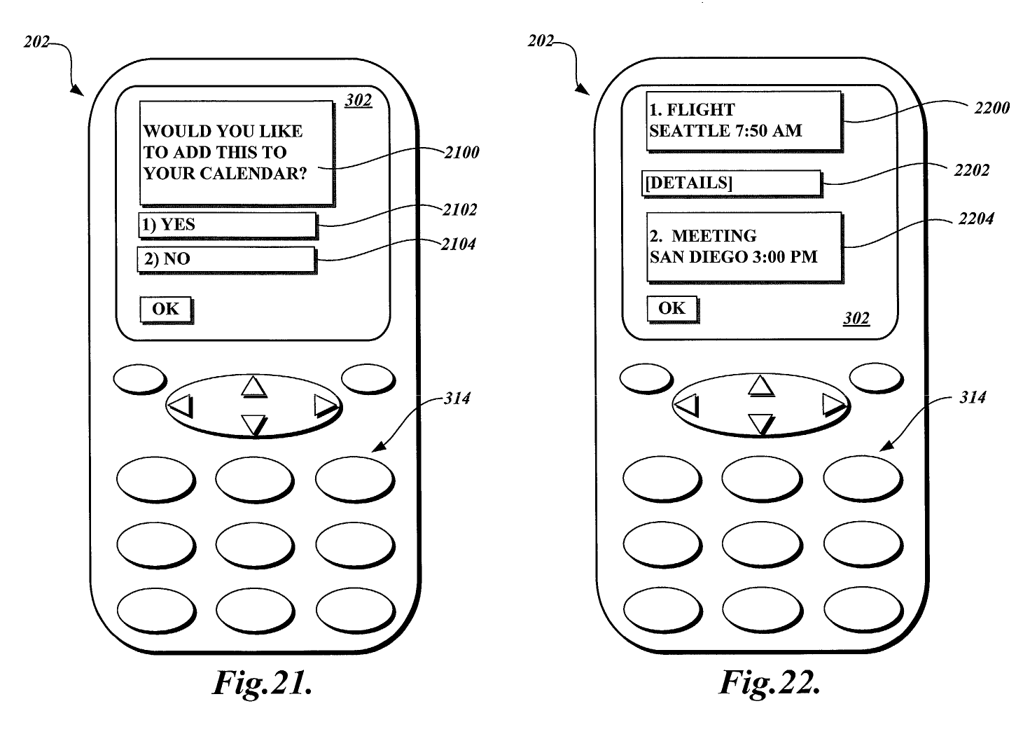

FIGS. 139-20 are block diagrams of various mobile device screen displays 302 illustrated the processing of a restaurant reservation corresponding to an appointment request in accordance with the present invention. With reference to FIG. 19, the screen display 302 can include various fields for allowing the user to select a restaurant reservation. More specifically, in an illustrative embodiment, the screen display 302 includes a food category field 1900, a price range field 1902, a range from a designated location field 1904, and a reservation time field 1706. The PIM application 324 may include default values for the fields by obtaining user reservation preferences from the personal information database 214. Additionally, the PIM application 324 may utilize additional information from the appointment request, such as location, to facilitate the identification of applicable restaurants. The user can also manipulate the field data by manipulating the keypad 314 or a pointing device, by issuing a voice command, or a combination thereof. The screen display 302 can also include an action field 1908 for allowing the user to instruct the PIM application 324 to search for applicable car rental reservations.

In an illustrative embodiment of the present invention, the PIM application 324 may transmit the user preferences/selections to the PIM interface application 410. Once any corresponding hotel reservations have been found, the PIM application 324 may display the car rental reservation information to the user. FIG. 20 is a block diagram illustrative of a screen display utilized by the PIM application 324 to provide a user with more detailed information regarding a potential restaurant reservation'. The screen display can include a detail field 1800 for displaying details of the restaurant. The screen display 302 can also include a number of actions fields 1802, 1804, and 1806 for allowing the user to make the reservation, obtain directions to the restaurant, and/or search for additional restaurant reservations. Similar to some of the other screen displays, the user can manipulate the field data by manipulating the keypad 314 or a pointing device, by issuing a voice command, or a combination thereof. Once the restaurant reservation is completed, at block 1018, the subroutine terminates.

Returning to FIG. 5, once the various reservations have been processed at block 510, the PIM application 324 schedules the appointment, along with the reservations at block 512. Once the reservation data has been entered into the calendar, at block 516, the routine 500 terminates.

FIGS. 21-22 are block diagrams of screen displays 302 generated by a mobile device 202 to incorporate reservations into a user calendar. With reference to FIG. 21, the screen display 302 includes a query field 2100 asking the user whether they would like the reservations added to the calendar. Additionally, the screen display 302 can also include two action fields 2102 and 2104 for obtaining the user input.

Referring now to FIG. 22, if the user adds the reservations to the calendar, the screen display 302 can include details of the meeting for user reminders/confirmation. As illustrated in FIG. 22, the screen display 302 can include one or more detail fields 2200 and 2204 and an action field 2202 for obtaining additional details. Accordingly, the user can navigate the screen display by manipulating the keypad 314 or a pointing device, by issuing a voice command, or a combination thereof.

In accordance with aspects of the present invention, a user can obtain one or more appointment requests. Additionally, with the PIM application 324 the user can obtain any corresponding reservations as part of the calendaring function.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. A method for integrating a calendaring and a reservation request, the method comprising:
obtaining the request for an appointment;
determining whether the appointment corresponds to one or more possible reservations;
displaying a set of reservations items corresponding to the appointment request;
obtaining the user selection of at least one reservation item; and
transmitting a reservation request corresponding to the user's selection of the reservation items.

2. The method as recited in claim 1, wherein the set of reservation items includes at least one travel reservation item.

3. The method as recited in claim 2, wherein the set of reservation items includes an airline travel reservation item.

4. The method as recited in claim 1, wherein the set of reservation items includes at least one car rental reservation item.

5. The method as recited in claim 1, wherein the set of reservation items includes at least one hotel reservation item.

6. The method as recited in claim 1, wherein the set of reservations items includes at least one restaurant reservation item.

7. The method as recited in claim 1, wherein determining whether the appointment corresponds to one or more possible reservations, including comparing a location of the user with the location of the appointment request.

8. The method as recited in claim 1, wherein displaying a set of reservation items includes displaying a hierarchical set of reservation items on a mobile device display.

9. The method as recited in claim 1, wherein transmitting reservation requests includes transmitting a reservation request to a third-party reservation server.

10. The method as recited in claim 1, wherein transmitting reservation requests includes transmitting a reservation request to a travel service provider.

11. The method as recited in claim 10, wherein the travel service provider is a third-party travel service provider.

12. A computer-readable medium having computer-executable instructions for performing the method recited in any one of claims 1-11.

13. A computer system having a processor, a memory, and an operating environment, the computer system operable to perform the method recited in any one of claims 1-11.

14. In a mobile computing device having a display and at least one input device, a method for integrating a calendaring and reservation request, the method comprised of:
displaying a request for an appointment;
determining whether the appointment request corresponds to one or more possible reservations;
displaying a set of reservation items on the mobile device display corresponding to the appointment request;
obtaining from the input device a user selection of at least one reservation item; and
transmitting the user's selection.

15. The method as recited in claim 14, wherein the set of reservation items includes at least one travel reservation item.

16. The method as recited in claim 14, wherein the set of reservation items is selected from a group consisting of airline travel reservation items, car rental reservation items, hotel reservation items, and restaurant reservation items.

17. The method as recited in claim 14 further comprising obtaining user-specified reservation preferences for at least one reservation item, wherein transmitting the user's selection includes transmitting the user-specified reservation preferences.

18. The method as recited in claim 17, wherein displaying a set of reservation items on the mobile device display includes utilizing the specified reservation preferences to determine the set of reservation items.

19. The method as recited in claim 14, wherein displaying a set of reservation items corresponding to the appointment request includes hierarchically displaying a set of reservation items on the mobile device display.

20. A computer-readable medium having computer-executable instructions for performing the method recited in any one of claims 14-19.

21. A computer system having a processor, memory, and an operating environment, the computer system operable to perform the method recited in any one of claims 14-19.

22. A personal information system for integrating calendaring and reservation processes, the system comprising:
one or more mobile devices having a display; and
a personal information manager server operable to determine whether a user appointment request corresponds to one or more possible reservations, wherein the personal information manager server is further operable to transmit a set of reservation items corresponding to an appointment request;
wherein the mobile device is operable to display the set of reservation items, to obtain the user's selection of the set of reservation items, and to transmit the selection to the personal information manager server.

23. The system as recited in claim 22, wherein the personal information manager server is further operable to transmit a reservation request corresponding to the user's selection to a travel service provider.

24. The system as recited in claim 23, wherein the travel service provider is a third-party travel service provider.

25. The system as recited in claim 22, wherein the personal information manager server is operable to transmit a reservation request corresponding to the user selection to a travel service server.

26. The system as recited in claim 25, wherein the travel service server is a third-party travel service server.

27. The system as recited in claim 22, wherein the reservation items include at least one travel related reservation item.

28. The system as recited in claim 22, wherein the reservation items are selected from a group consisting of airline travel reservation items, car rental reservation items, hotel reservation items, and restaurant reservation items.

29. The system as recited in claim 22, wherein the personal information manager server is further operable to store user reservation preferences and to utilize the user reservation preferences in selecting the set of reservation items.

30. The system as recited in claim 29, wherein the personal information manager server is further operable to utilize the user reservation preferences to transmit reservation requests based on the user selection of at least one of the reservation items.
